(19) United States
(12) Patent Application Publication
(10) Pub. No.: US 2020/0272936 A1
(43) Pub. Date: Aug. 27, 2020

(54) System and Method for Managing Inventory of Artificial Intelligence Entities

(71) Applicant: Gad SOLOTOREVSKY, Even Yehuda (IL)

(72) Inventor: Gad SOLOTOREVSKY, Even Yehuda (IL)

(21) Appl. No.: 16/285,409

(22) Filed: Feb. 26, 2019

(51) Int. Cl. G06N 20/00; G06F 16/25; G06F 16/28; G06N 5/02

(52) U.S. Cl. CPC G06N 20/00; G06N 5/02; G06F 16/288; G06F 16/254

(57) ABSTRACT

A method and software are provided. The method comprises: a) providing physical platforms, each comprising a software module enabling it to operate as an artificial intelligence entity; b) providing an AI based application software configured to monitor operation of the physical platforms, that comprises: a data collection layer at which data sets generated at the plurality of physical platforms are retrieved, processed and loaded to a database; a data storage layer in which data sets are stored; a data analyzing layer comprising analyzing engines configured to analyze the data sets and establish relationships that exist between the physical platforms and their respective computing environment; a data modeling layer configured to detect changes that occurred in the physical platforms with respect to preceding data sets retrieved from the physical platforms, and identify which of the detected changes is associated with a computing environment.

### TECHNICAL FIELD

The present invention relates to methods and systems in the field of artificial intelligence. More particularly, the present invention relates to methods and systems for managing artificial intelligence and/or machine learning based components and solutions.

### BACKGROUND

One issue that is crucial for providers and owners of Machine Learning and artificial intelligence based solutions, is, to be able to monitor an inventory of their artificial intelligence (“AI”) based solutions and the status of these solutions, for example, which solutions are being implemented, where, are these solutions currently active, etc.

Machine learning and artificial intelligence based solutions are developed by using multiple different technologies and programming languages and are implemented in various environments and devices. Moreover, the technologies used for developing these solutions are continually evolving.

In addition, when considering the ever-growing number of Machine Learning and artificial intelligence based solutions in general, as well as the growing number of machine learning and artificial intelligence based components embedded in various IoT devices, such as in smart watches, smart vacuums cleaners, autonomous cars, smart thermostats, smart phones, and the like, it is obviously becoming more of a challenge to manage the required solutions.

Another requirement is to be able to analyze the performance of each of the instances (e.g. modules) comprised in the solutions, and detect deviations from their expected performances. This need is rather a challenging one since a single solution might have instances deployed in many IoT devices, and the expected performance of each of these instances is different from the others and is unknown at the time of creating the solution. For example, a smart thermostat might be installed in millions of households. However, a smart thermostat located in Sahara is naturally expected to exhibit a different performance that a smart thermostat located at Antarctica. This performance cannot be pre-defined as part of the design of the thermostat but needs to be learned during the operation of the thermostat at the location where it is installed, otherwise different thermostats will have to be designed for different locations, which is obviously an inferior solution to such a problem.

Deviations from the expected performance occur in some cases due to changes in the computational environment, e.g., changes that occur in the versions of the dynamic linked libraries or changes that occur in the sensors deployed as part of the instance comprised in the Machine Learning and artificial intelligence solution. As can be appreciated by those skilled in the art, it is important to identify changes in the computational environment and to analyze the relationship between the identified changes in the performance of the solution and the changes that occurred in the computational environment.

There is a need to maintain an inventory of large amount (in the order of millions, or even billions) of instances of the artificial intelligence and machine learning solutions, detect changes in the expected performance of each of these instances, analyze the changes occurred with respect to changes occurring in their respective computational environments of each of the instances, all while carrying these activities with minimal impact and restrictions on the methodologies and technologies used for developing and deploying the artificial intelligence and or machine learning solutions, and while having a minimal effect on the performance of the artificial intelligence and or machine learning solutions.

Unfortunately, there is no adequate solution that fulfills these needs suggested in the art, and therefore the present invention seeks to provide a method and a system that address these needs.

### SUMMARY OF THE DISCLOSURE

The disclosure may be summarized by referring to the appended claims.

It is an object of the present disclosure to provide a novel method and a software, for managing an inventory of artificial intelligence and/or machine learning based entities, to enable tracking their performance, to detect deviations from expected performance, and analyze these deviations.

It is another object of the present disclosure to provide a novel method and a software, for monitoring a plurality of artificial intelligence and/or machine learning based entities, and analyze their behavior based on their relationships with their own computing environment.

Other objects of the present invention will become more apparent from the following detailed description of the invention taken together with the accompanying examples and appended claims.

In accordance with a first embodiment of the present invention, there is provided a method comprising:
a) providing a plurality of physical platforms each comprising one or more software modules configured to enable each of the plurality of physical platforms to operate as an artificial intelligence entity;
b) providing an AI based application software configured to monitor operation of the plurality of physical platforms, that comprises:

a data collection layer at which data sets generated at the plurality of physical platforms are retrieved, processed and loaded to a database;

a data storage layer in which the data sets from the data collection layer are stored;

a data analyzing layer comprises one or more analyzing engines configured to analyze the data sets and establish relationships that exist between the plurality of physical platforms and their respective computing environment;

a data modeling layer configured to use the data sets stored in the data storage (such as a database, a file system, Hadoop Distributed file system, and the like) and the results derived from the one or more analyzing engines to detect changes that occurred in one or more of the plurality of physical platforms with respect to preceding data sets retrieved from the one or more of the plurality of physical platforms, and identify which of the detected changes is associated with a computing environment.

For the purposes of explanation henceforth the term “AI based applications” as will be used herein throughout the specification and claims should be understood as a general name for artificial intelligence and/or machine learning based components, entities, applications, software, solutions, etc.

The term “computing environment” as used herein throughout the specification and claims is used to refer either to an operational environment which relates to a physical environment or to a software environment in which the AI based application resides, or to both.

According to another embodiment, the method provided is used for managing an inventory of artificial intelligence and/or machine learning based applications.

By yet another embodiment, the inventory of artificial intelligence and/or machine learning based applications are embedded in IoT devices.

The term IoT (Internet of things) as used herein refers to a network of entities (e.g. devices such as vehicles, and home appliances) that contain electronics, software, sensors, actuators and connectivity which allows such entities to connect, interact and exchange data.

In accordance with another embodiment, the IoT devices is at least one member of a group that consists of: a smart watch, a smart vacuum cleaner, an autonomous car, a smartphone a smart thermostat, a smart health monitoring device, a smart health diagnostic device, and a smart appliance, and the like.

According another aspect of the present invention there is provided a computer program product encoding a computer program stored on a non-transitory computer-readable medium for executing a set of instructions by one or more computer processors for carrying out a method for monitoring operation of a plurality of physical platforms comprising software modules to enable each of the plurality of physical platforms to operate as an artificial intelligence entity, wherein the method comprising:

retrieving data sets generated at the plurality of physical platforms;

storing data retrieved in a database;

analyzing said data sets and establishing relationships that exist between said plurality of physical platforms and their respective computing environment;

applying a model for using the data sets stored in the database and the results derived from the one or more analyzing engines to detect changes that occurred in one or more of the plurality of physical platforms with respect to preceding data sets retrieved from the one or more of the plurality of physical platforms, and identifying which of the detected changes is associated with a computing environment.

According to still another embodiment, the computer program product is configured to be used for managing an inventory of artificial intelligence and/or machine learning based applications. Preferably, the inventory of artificial intelligence and/or machine learning based applications are embedded in IoT devices.

### BRIEF DESCRIPTION OF THE DRAWINGS

The accompanying drawings, which are incorporated herein and constitute a part of this specification, illustrate several embodiments of the disclosure and, together with the description, serve to explain the principles of the embodiments disclosed herein.

FIG. 1 illustrates an example of a sub-system construed in accordance with an embodiment of present invention;

FIG. 2. illustrates a block diagram construed in accordance with an embodiment of the present invention;

FIG. 3 Illustrates an AI based solution submitting information to the system;

FIG. 4 Illustrates a multitude of AI based solutions submitting information to the system;

FIG. 5 Is a block diagram that Illustrates the main elements of the data analysis component; and

FIG. 6 Is a block diagram that Illustrates the creation and update of a model of a time series.

### DETAILED DESCRIPTION OF EXEMPLARY EMBODIMENTS

Some of the specific details and values in the following detailed description refer to certain examples of the disclosure. However, this description is provided only by way of example and is not intended to limit the scope of the invention in any way. As will be appreciated by those skilled in the art, the claimed method and device may be implemented by using other methods that are known in the art per se. In addition, the described embodiments comprise different steps, not all of which are required in all embodiments of the invention.

The present invention provides a method and a system for maintaining an inventory of artificial intelligence and/or machine learning based components, applications, software, and solutions, track their performance, detect deviations from their expected performance and analyze the relationship between deviations and changes occurring in the computational environment.

As already explained above, the term “computing environment” as used herein throughout the specification and claims is used to refer either to a physical environment or to a software environment at which the AI based application resides, or to a combination of both these environments. Examples for a physical environment are: the type of the computing device, the model of the computer/smart phone/IoT device, the CPU, the size of RAM associated with the relevant device, and sensors, such as camera, thermostat, and motion sensors, that are being used.

Furthermore, the term physical environment referred to above, will also be used to encompass emulated physical components such as the CPU and RAM of virtualized environments such as Dockers, VMWare, VirtualBox and the like. Examples of the software environment components are operating systems such as Linux or Windows, interpreters such as Java Virtual Machine and Python shell, and the software libraries used, including both dynamically and statically linked libraries.

Typically, AI based applications are developed by using various technologies and computing languages such as C/C++, Python, R, TensorFlow. The AI based applications may reside in any one of many physical environments such as computers, smartphones, autonomous cars, smart watches, and the like. During the lifecycle of an AI based application, the computing environment might undergo many changes. For example, the dynamic linked libraries versions might change, updates might be affected to the operating system, additional RAM may be applied, and sensors might be replaced. Such changes can obviously affect the performance of the AI based application. For example, the accuracy of an AI based application which is used for detecting traffic signs could be improved when the sensor (e.g. the camera) is upgraded to a better resolution camera. The performance of an AI based application could also be improved or degraded upon upgrading a dynamic linked library used by the AI based application for doing image processing, to a newer version.

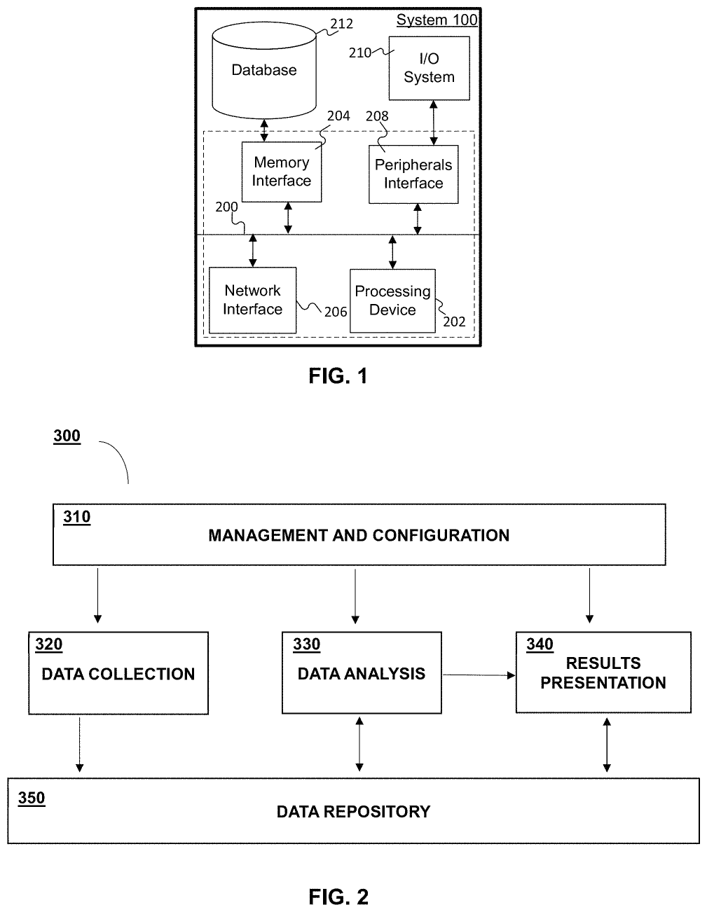

FIG. 1 is a block diagram of an example of components of sub-system 100. A system construed in accordance with the present disclosure, aims to manage Artificial intelligence and/or Machine Learning based components and applications, may comprise a plurality of sub-systems, to enable achieving the required managing of such Artificial intelligence and/or Machine Learning based components and applications.

In one embodiment, the system may include a bus 200 (or other communication mechanism) that interconnects subsystems and components for transferring information within sub-system 100. For example, bus 200 may interconnect a processing device 202, a memory interface 204, a network interface 206, and a peripherals interface 208 connected to I/O system 210. Processing device 202, shown in FIG. 1, may include at least one processor configured to execute computer programs, applications, methods, processes, or other software to perform embodiments described in the present disclosure.

The term “processing device” refers to any physical device having an electric circuit that performs a logic operation. For example, the processing device may include one or more integrated circuits, microchips, microcontrollers, microprocessors, all or part of a central processing unit (CPU), graphics processing unit (GPU), digital signal processor (DSP), field programmable gate array (FPGA), or other circuits suitable for executing instructions or performing logic operations. The processing device may include at least one processor configured to perform functions of the disclosed methods such as a microprocessor manufactured by Intel™ or by AMD™. The processing device may include a single core or multiple core processors executing parallel processes simultaneously. In one example, the processing device may be a single core processor configured with virtual processing technologies. In another example, the processing device may include a multiple-core processor arrangement (e.g., dual, quad core, etc.) configured to provide parallel processing functionalities to allow a device associated with the processing device to execute multiple processes simultaneously. It is appreciated that other types of processor arrangements could be implemented to provide the capabilities disclosed herein.

In some embodiments, processing device 202 may use memory interface 204 to access data and a software product stored on a memory device or a non-transitory computer-readable medium. For example, sub-system 100 may use memory interface 204 to access memory device 212. Memory device 212 may include high-speed random access memory and/or non-volatile memory such as one or more magnetic disk storage devices, one or more optical storage devices, and/or flash memory (e.g., NAND, NOR). Memory device 212 may store an operating system, such as LINUX, iOS, UNIX, OS X, WINDOWS, or an embedded operating system such as VXWorkS. The operating system can include instructions for handling basic system services and for performing hardware dependent tasks. In some implementations, the operating system can be a kernel (e.g., UNIX kernel).

As used herein, a non-transitory computer-readable storage medium refers to any type of physical memory on which information or data readable by at least one processor can be stored. Examples include random access memory (RAM), read-only memory (ROM), volatile memory, nonvolatile memory, hard drives, CD ROMs, DVDs, flash drives, disks, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The terms “memory” and “computer-readable storage medium” may refer to multiple structures, such as a plurality of memories or computer-readable storage mediums located within sub-system 100, or at a remote location. Additionally, one or more computer-readable storage mediums can be utilized in implementing a computer-implemented method. The term “computer-readable storage medium” should be understood to include tangible items and exclude carrier waves and transient signals.

In some embodiment, sub-system 100 may include network interface 206 coupled to bus 200 that is configured to provide a two-way data communication to a communications network. In one embodiment, network interface 206 may include an asymmetric digital subscriber line (ADSL) card, cable modem, or a satellite modem. As another example, network interface 206 may include a local area network (LAN) card to provide a data communication connection to a compatible LAN. In another embodiment, network interface 206 may include an Ethernet port connected to radio frequency receivers and transmitters and/or optical (e.g., infrared) receivers and transmitters. The specific design and implementation of network interface 206 depends on the communications network(s) over which sub-system 100 is intended to operate. For example, in some embodiments, capturing device 105 may include network interface 206 designed to operate over a GSM network, a GPRS network, an EDGE network, a Wi-Fi or WiMax network, and a Bluetooth® network. In any such implementation, network interface 206 may be configured to send and receive electrical, electromagnetic or optical signals that carry digital data streams representing various types of information.

Sub-system 100 may also include peripherals interface 208 coupled to bus 200. Peripherals interface 208 may be connected to devices and subsystems to facilitate multiple functionalities, such as for example printing the outcome obtained by executing the algorithm disclosed herein for a given individual. In one embodiment, peripherals interface 208 may be connected to I/O system 210 configured to receive signals or input from devices and providing signals or output to one or more devices that allow data to be received and/or transmitted by sub-system 100 (e.g. retrieving data to be used while executing the algorithm disclosed herein). In one example, I/O system 210 may include a touch screen controller, an audio controller, and/or other input controller(s). The touch screen controller may be coupled to a touch screen and can, for example, detect contact, movement or break thereof using any of a plurality of touch sensitivity technologies, including but not limited to capacitive, resistive and infrared technologies as well as other proximity sensor arrays or other elements for determining one or more points of contact with the touch screen. In addition, I/O system 210 may include a display screen (e.g., CRT or LCD) in place of the touch screen. The audio controller may be coupled to a microphone and a speaker to facilitate voice-enabled functions, such as voice recognition, voice replication, digital recording, and telephony functions.

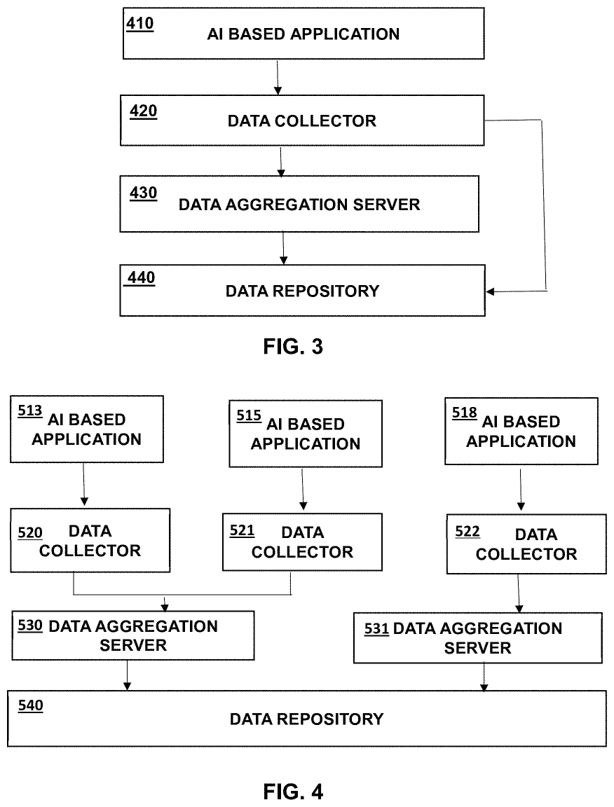

FIG. 2 presents a block diagram, illustrating main components of a system construed in accordance with an embodiment of the present invention. Block 310 is responsible for the management and configuration of other components comprised within system 300. The management can be done by using one or a plurality of methods that are known in the art per se, such as by implementing a graphic user interface, or configuration files. The data collection entity, block 320, is configured to collect information received from one or more AI based applications, such as measured values of certain parameters, information that relates to the computing environment, etc. The data collection component processes the information received and stores it at a data repository, 350. One option for implementing a data collection block is further described below in more details, in connection with FIG. 3.

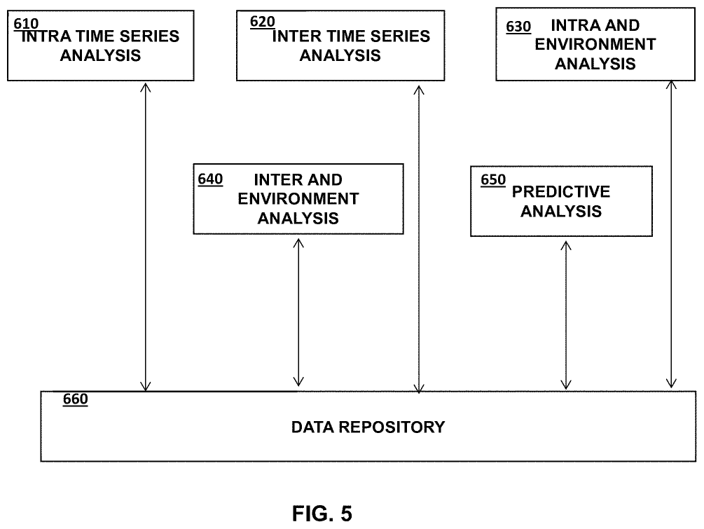

Data analysis block 330, is configured to analyze data arriving either directly from management and configuration block 310, or data that were stored at data repository 350. The analysis carried out by data analysis block 330 may include for example the following functionalities: detection of outliers comprised in the measured values, detection of changes that occurred in the computational environment, finding relationships between outliers detected and changes detected in the computational environment, identifying common performances for various instances that belong to the same AI based application, finding common performance changes between different AI based applications that occur while using similar components thereof, and the like. The results of the analysis are stored at data repository 350. One option for implementing such a data analysis block is further described below in more details, in connection with FIG. 5.

Results presentation block, 340, may present data stored at data repository 350 and/or results derived either directly from data analysis block component 330, using methods such as graphic user interfaces, static and dynamic reports, web portals, and APIs to human users and or external systems, or indirectly, after their storage at data repository block 350. In addition, or in the alternative, result presentation components may also present information that was retrieved for from human users and/or from external systems. The results presentation block 340 may present for example a result that relates to an outlier detected by the data analysis block 330. This result may be presented by presentation block 340 to an external entity, which may be either a human user or another system that requires receiving the analysis results. The entity presented with the result (either the human user or the other system) may optionally confirm or negate that the detected outlier is truly an outlier. If such information is indeed received from the external source, it would preferably be stored at data repository 350, and may be used later by data analysis component 330, as described in FIG. 5.

FIG. 3 illustrates an embodiment of the present invention according to which an AI based application submits information to the system. AI based application 410, forwards reports to data collector 420. The reported data includes among others the identification of that AI based application, for example the application name, an application module identification information, and information concerning the computing environment, e.g. the versions of the software libraries that are currently implemented by the AI based application, and information about the performance of the AI based application. Different AI based applications might have different parametric values, that can be used to categorize their performances. For example, the performance of an application whose role is to identify people in images (e.g. photos), might be characterized by the percentage of incorrect identifications, taken together with the average time it took the application to identify a person. The reporting might be done by using any technique that is known per se including but not limited to writing the information to a database, to a file, or using a REST API. The reporting can take place periodically, for example in a daily basis or on a minute basis, etc. Alternatively, or in addition, a report may be generated every time a certain event occurs. For example, each time an application, whose role is to identify people that appear in photos/videos, detects a face which it cannot identify.

In some embodiments, data collector 420 is configured to manipulate the data provided by the AI based application 410 in order to create a more concise data. For example, if the AI based application is configured to forward information each minute about the computing environment to the data collector, the latter may convert the received information into a base line and deviations that occur over time, as compared with that base line. Alternatively, if an AI based application provides information each minute about values of parameters of certain characteristics, then the data collector 220 can be configured to convert the information received into hourly averages.

In some embodiments, the information that relates to the computing environment might be all-inclusive, e.g., information about all the sensors and libraries used, and their current versions. In other embodiments, the information about the computing environment might be very limited or even non-existing, e.g., only the MAC address of the device at which the solution module has been deployed.

In some embodiments the communication between the AI based application 410 and data collector 420 is unidirectional, the AI based application forwards information to the data collector, while in other embodiments, the forwarding of information is carried out in both directions, namely, data collector 420 receives data from the AI based applications 410 and forwards requests or data to the AI based application 410. For example, the data collector may forward requests to receive data, and/or may send acknowledgments that data has been received.

In other embodiments the data collector may be configured to store at least some of the data received from the AI based application at a permanent repository such as a file or a database (e.g. data repository 440). In other embodiments, data collector 420 is associated with a volatile storage, such as a RAM, to store that data.

Next, data collector 420 forwards the manipulated data to data aggregation server 430. The data may be forwarded to data aggregation server 430 according to a predefined time schedule, e.g., once per day. Alternatively, the data may be forwarded whenever the amount of data received by data collector 420 exceeds a pre-defined threshold. e.g., over 20 Kilobytes. By another alternative, the data may be forwarded whenever it is requested by the data aggregation server 430. Another option is that the data collector forwards the data to the data aggregation server 430, immediately upon receipt.

Data collector 420 may also be configured to forward to data aggregation server 430 only part of the data received at data collector 420. For example, in the case of an AI based application being used to identify people in photos, the data collector may be configured not to forward (or hide) the description of the two measurements collected by AI based application, namely, “percentage of incorrect identifications”, and “average time required to identify a person”, and not hide the values associated with these two measurements, for instance, if the value of “average time required to identify a person” is 4.5 milliseconds, then the data collector could be configured to mask the description of the measurement by a meaningless string such as “dutfyuit676765” while still forwarding to the data aggregator server, a message that comprises: measurement: “dutfyuit676765” value: 4.5.

In an embodiment of the present disclosure, the data is forwarded to the data aggregation server in an encrypted form.

The functionality of the data collector, for example how should it manipulate the data received from the AI based application, which fields of the data received should be masked, when and how to forward data to the data aggregation server, and the like, can be determined by using methods known in the art per se, such as by using configuration files or by using a graphical user interface, GUI.

The data aggregation server 430, receives data from one or more data collectors and is configured to store the data in data repository 440. The data aggregation server 430 may conduct quality checks, such as checking for duplicate data received from the data aggregation server, and may be configured to ignore part of the received data, or correct the received data prior to storing it at the data repository. In addition, data aggregation server 430 may also manipulate the data prior to having it stored at data repository 440. For example, it may generate calculated values that are based on the results of measurements it had received, or it may aggregate data received, for example it may aggregate hourly measurements data received from the data collector into daily data, and store the daily data at the data repository 440.

As will be appreciated by those skilled in the art, some or all of the data collector functionality may be integrated as part of the data aggregation server functionality, and such an option should be understood as being encompassed within. the scope of the present invention.

Data repository 440 is a data storage configured to store data thereat and retrieve information therefrom by using any applicable method. selected. from. different data repository technologies known in the art per se, or any combination thereof, such as using a relational database, a non-relational database, a file system, and Hadoop Distributed file system, i.e., “HDFS”.

The scenario presented in FIG. 3 relates to a single AI based application 410 which is linked to a single data collector 420 connected to a single data aggregation server 430, and the latter is connected to data repository 440.

FIG. 4 illustrates another embodiment by which there is a plurality of AI based applications 513, 515 and 518 that are linked to a number of data collectors, 520, 521 and 522, which are configured to forward collected data to a plurality of data aggregation servers 530 and 531, which in turn forward the information to data repository 540.

In the example illustrated herein, the identification conveyed by an AI based application to the data collector may further comprise a grouping and/or hierarchical structure of AI based applications. For example, there may be many cases where an AI based application which is configured to identify people in photos, is implemented in smart security systems. Such security systems may be deployed in different enterprises, where an enterprise may have a plurality of branches located in different countries. Each of the AI based application's modules may send to the data collector server, apart from the AI based application name and/or module id, also information that identifies the enterprise to which the module belongs and the country at which it is deployed.

Optionally, either the data collector or the data aggregator server or both, may use the grouping or hierarchical information provided by the AI based application when aggregating data received. For example, the data collector(s) may aggregate data records by the country from which the data has been retrieved and forward the aggregated records to the data aggregators servers, which in turn may generate further aggregations, such as on an enterprise basis, and store only these aggregations at the data repository.

FIG. 5 depicts distinct analyses that can be performed by the data analysis component. The analysis engines depicted in this figure are presented for illustrative purposes, and any additional applicable analysis engines may be added, in the alternative, only part of these analysis engines are deployed. Analysis engines 610, 620, 630, 640, and 650, retrieve information from data repository 660, perform the respective analysis, and have the results of the analysis stored at the data repository. The information retrieved by analysis engines 610, 620, 630, 640, and 650, may include among others data that had been stored at the data repository by the data aggregation server, data stored by third parties and/or human users, and data previously stored by the analysis engines 610, 620, 630, 640, and 650 themselves.

The following example refers to an analysis performed by a passport control application, which is an application that has an AI based component whose role is to identify if the photo comprised in a person's passport, corresponds to people whose photos are stored in various databases, for example, a database comprising photos of suspicious people, a database comprising photos of people that have entered the country during the last year but have not departed yet, and the like. The passport control application may provide via a data collector a value for the percentage of passport photos which were identified as a photo included in the databases. Such a passport control application may also provide for example, via a data collector, information that relates to the computing environment, that may include information about the model and version of the scanner used for scanning photos. The same solution is associated with a plurality of modules, and at each border control station in every airport, a module of this passport control application can be installed.

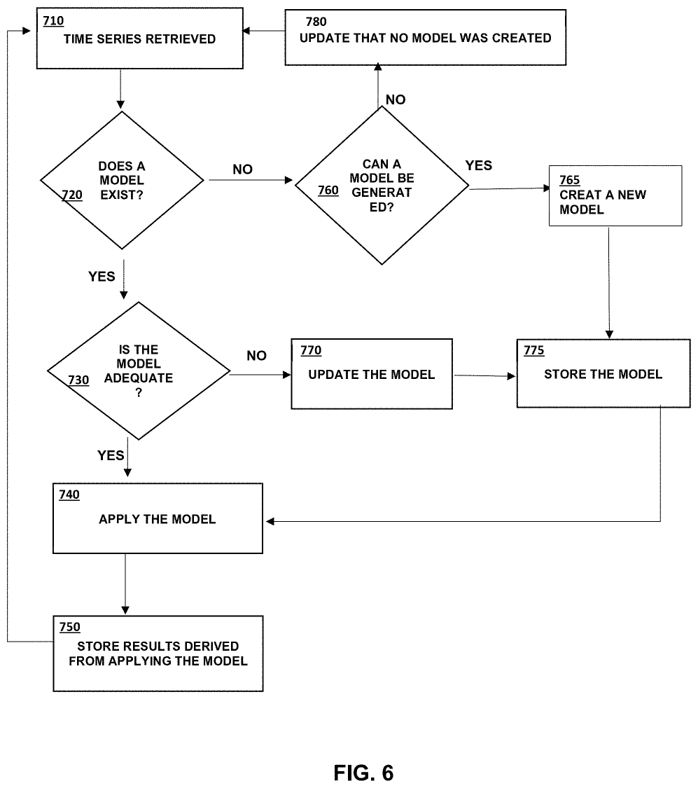

The intra time series analysis engine 610, is configured to analyze the individual time series submitted by the modules of the AI based applications, to check if there are outliers or unexpected values in each of the time series. In the passport control application example referred to above, the intra time series analysis 610 will check separately for each module associated with this application, if there are outliers. FIG. 6 illustrates an example of such an intra time series analysis.

Inter time series analysis engine 620, is configured to analyze relationships that exist between time series of different modules belonging to the same machine learning solution. In the above airport control application example, engine 620 will analyze the relationship that exist between different modules of the same application, for example, it may be used to determine that at a certain airport, the percentage of passport photos identified as photos included in various data repositories has decreased as of a certain date, while in other airports there has been no such change.

Intra and environment analysis engine 630, is configured to perform an analysis of particular individual time series while taking into account changes that occurred in the computational environment. For example, engine 630 may detect that certain outliers or changes in the performance of a time series associated with a specific instance (module), where the latter is located at a specific passport control station, is related to a change in the version of the scanner's software used to scan the passports of people going through that station.

Inter and environment analysis engine 640, is configured to analyze relationships that exist between the time series of different modules associated with the same machine learning solution and the computational environment of each of these modules. For example, the percentage of photos' recognition is determined by the passport control application to increase following an upgrade of the scanner firmware. Engine 640 may also be configured to analyze information derived from different applications, by using one or more common computational environment components. For example, engine 640 may detect that a change in the scanner firmware has had an impact upon different AI based applications, and not only on different instances (modules) of the same AI based application that for which the scanner is used.

Predictive analysis engine 650, is configured to predict (e.g. based on a going forward analysis) the expected impact of changes if and when these changes will occur in the computational environment, on different AI based solutions. The analysis can be used to predict if a change is safe and will have no adverse effect on the performance of the AI based solution.

It should be noted that the examples provided above of analyses performed by analysis engines 610, 620, 630, 640 and 650 are relatively simple analysis for detecting simple relationships. As may be appreciated by those skilled in the art, the analyses that can be carried out by engines 610, 620, 630, 640, and 650 may be done while using many different technologies and algorithms or a combination thereof, such as different Machine learning methods, or different statistical analysis methods. These analyses may reveal and generate deeper and more complex insights than those described in the above examples.

The analyses that are carried out by the software engines described above, may be conducted completely automatic, while in the alternative, human users input and/or manipulation may be associated with the analysis process.

The results of the different analysis engines are preferably stored at the data repository, and may be displayed to users and other third parties via the results presentation component, present in FIG. 2 (element 340).

The data repository used in such a system construed in accordance with an embodiment of the present invention, may be a single data repository used for storing time series, models, information provided by third parties, validation of outliers detected by the model, and information about outliers that were not necessarily detected by the model. In the alternative, the information may be stored in parts at a plurality of data repositories, and will be retrieved from the respective data repository at which the relevant information had been stored. Also, a plurality of AI based applications and/or servers for carrying out the analysis described above, may operate in parallel.

FIG. 6 presents a flow chart exemplifying the intra time series analysis shown in FIG. 5 (element 610), wherein the method exemplified in this flow chart is construed as an embodiment of the present invention. In step 710 information relating to time series is received from the data repository. The information preferably includes time series observations, time stamps and values, information about the last model applied, if such a model has already been generated by the relevant AI based applications and/or server for carrying out the analysis as described in FIG. 4 above for this time series. This information may include some or all of the following items: the model type, for example ARMA, the model itself, information about outliers, if any, detected in previous applications when the model was applied to the time series, validation by third parties, for example by human experts, of the outliers detected by the model. For example, information provided by third parties for identifying some of the points included in the time series as being outliers (not necessarily the same points that were identified as outliers while executing the model).

In step 720, the process determines if a model for the retrieved time series has already been generated, and if such a model indeed exists, then in step 730 the process determines if the model is currently adequate to be used. Different criteria may be applied in order to reach the latter determination. For example, the ratio found between the number of observations within the time series and the number of observations within the time series that were used to generate the model, or the ratio found between the number of outliers detected by the model and the number of detected outliers that were rejected by a human user.

If the model has been determined to be an adequate one, it will be applied in step 740. The model used in this example is a model for detecting anomalies or outliers, based on certain pre-defined criteria, such as for example, distance of a value in the time series from the values expected by the model, or the likelihood of a value to be found in the time series according to the model. The results obtained by applying the model are stored in the data repository. They may include for each data point a flag indicating if that data point may be associated with an outlier or not, and/or one or a plurality of scores, such as likelihood or confidence in the results obtained according to at least one criterion used to flag the data point as an outlier. In step 750, the results obtained by applying the model, for example the detected outliers, are stored in a data repository (see for example FIG. 5, element 660).

Once the processing of the time series data has been completed, the system may proceed by carrying out step 710, for confirming whether there is a new time series that needs to be processed. Alternatively, the system may end the process until it will be activated once again, e.g. such an activation can be made by a task scheduler, or by a call via an API.

If the system identifies in 720 that there is no model available for the time series retrieved in step 710, the process continues by carrying out step 760 to establish if a model can be generated. In certain cases, such as if the time series comprises a single observation, or if all the observations included in the time series are identified as outliers, it would not be possible to generate a meaningful model. If no model can be generated, this outcome will be updated accordingly in the data repository, and the process proceeds to step 710 and operate on the next time series.

If the system determines in step 760 that a model can be generated, then the system generates in step 765 an appropriate model. Different methods may be used for generating a model, such as generating a linear model, a deep neural network model, or an autoregressive integrated moving average, a.k.a. ARIMA, model. Once a model has been generated, it is stored in step 775 in the relevant data repository, and the model could be applied to the data set as the process returns to step 740 described above.

If the determination made in step 730, described above, is that the existing model is not adequate for the given time series, then in step 770, the system updates the model to make it adequate for use for the given time series. Such an update can be done for example by generating a new model from scratch (step 765) or by tuning parameters associated with the existing model. Once the model has been updated, it is stored (step 775) at the data repository, and the process proceed to step 740, by which the model is applied to the currently retrieved time series.

It is to be understood that the above description only includes some embodiments of the invention and serves for its illustration. Numerous other ways of carrying out the methods provided by the present invention or the use of different parameters, may be devised by a person skilled in the art without departing from the scope of the invention, and are thus encompassed by the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method comprising:
a) providing a plurality of physical platforms each comprising one or more software modules configured to enable each of said plurality of physical platforms to operate as an artificial intelligence entity;
b) providing an AI based application software configured to monitor operation of said plurality of physical platforms, that comprises:
a data collection layer at which data sets generated at said plurality of physical platforms are retrieved, processed and loaded to a data storage;
a data storage layer in which the data sets from the data collection layer are stored;
a data analyzing layer comprises one or more analyzing engines configured to analyze said data sets and establish relationships that exist between said plurality of physical platforms and their respective computing environment;
a data modeling layer configured to use the data sets stored at the data storage and the results derived from said one or more analyzing engines to detect changes that occurred in one or more of the plurality of physical platforms with respect to preceding data sets retrieved from said one or more of the plurality of physical platforms, and identify which of the detected changes is associated with a computing environment.

2. The method of claim 1, used for managing an inventory of artificial intelligence and/or machine learning based applications.

3. The method of claim 1, wherein said inventory of artificial intelligence and/or machine learning based applications are embedded in IoT devices.

4. The method of claim 3, wherein said IoT devices is at least one member of a group that consists of: a smart watch, a smart vacuum cleaner, an autonomous car, a smartphone, a smart thermostat, a smart health monitoring device, a smart health diagnostic device, and a smart appliance.

5. A computer program product encoding a computer program stored on a non-transitory computer-readable medium for executing a set of instructions by one or more computer processors for carrying out a method for monitoring operation of a plurality of physical platforms comprising software modules to enable each of said plurality of physical platforms to operate as an artificial intelligence entity, wherein the method comprising:
retrieving data sets generated at said plurality of physical platforms;
storing data retrieved in a database;
analyzing said data sets and establishing relationships that exist between said plurality of physical platforms and their respective computing environment;
applying a model for using the data sets stored in the database and the results derived from said one or more analyzing engines to detect changes that occurred in one or more of the plurality of physical platforms with respect to preceding data sets retrieved from said one or more of the plurality of physical platforms, and identifying which of the detected changes is associated with a computing environment.

6. The computer program product of claim 5, used for managing an inventory of artificial intelligence and/or machine learning based applications.

7. The computer program product of claim 5, wherein said inventory of artificial intelligence and/or machine learning based applications are embedded in IoT devices.

8. The method of claim 7, wherein said IoT devices is at least one member of a group that consists of: a smart watch, a smart vacuum cleaner, an autonomous car, a smartphone, a smart thermostat, a smart health monitoring device, a smart health diagnostic device, and a smart appliance.
